(19) United States
(12) Patent Application Publication
(10) Pub. No.: US 2002/0168936 A1
(43) Pub. Date: Nov. 14, 2002

(54) Set top box enabled satellite receiver

(75) Inventors: Binyamin Zilberstein, Rockville, MD (US); Tod Munro Adamson, Boyce, VA (US)

Correspondence Address: BANNER & WITCOFF, 1001 G STREET N W, SUITE 1100, WASHINGTON, DC, 20001, US

(73) Assignee: Gilat Satellite Networks, Ltd., Kiryat Arye (IL)

(21) Appl. No.: 10/143,859

(22) Filed: May 14, 2002

Related U.S. Application Data
(60) Provisional application No. 60/290,350, filed on May 14, 2001.
(60) Provisional application No. 60/352,886, filed on Feb. 1, 2002.
(60) Provisional application No. 60/350,886, filed on Jan. 23, 2002.

(51) Int. Cl. H04B 7/185

(52) U.S. Cl. 455/12.1; 455/427

(57) ABSTRACT

VSAT networks may support one or more transaction terminals without modification to the transaction terminals. The VSAT indoor unit may include a reverse modem which emulates the local loop of a PSTN. Thus, the VSAT network may be connected directly to the transaction terminal without modification or recertification of the transaction terminal. Alternatively, the VSAT indoor unit may include a wireless LAN. This provides a cost effective interface to support credit, ATM, or other applications in accordance with aspects of the present invention. In this manner, the VSAT local retailer may retrofit existing terminals and/or ATM machines which may render obsolete the retailer's need to have any services from the local phone company. The VSAT indoor unit may also provide the local retailer with telephone access, Internet access, and broadband mass media services such as music and streaming video. This is particularly important in rural areas and in developing countries where a local telephone network is not always as reliable as desired by the retailer.

This application claims priority from provisional patent application, U.S. Ser. No. 60/290,350, filed on May 14, 2001, and provisional application, U.S. Ser. No. 60/352,886 filed on Feb. 1, 2002, herein incorporated by reference.

### FIELD OF THE INVENTION

The present invention relates generally to very small aperture satellite terminal (VSAT) networks, and more particularly it relates to an improved method and apparatus for transaction communications.

### BACKGROUND OF THE INVENTION

Retailers often employ transaction terminals such as ATM machines and/or verification terminals which verify credit cards, debit cards, and/or personal checks. Verification terminals are often found in small and large retailers. They typically include a credit card reader and an optional keypad interface. The verification terminals at many retail stores comprise a small terminal mounted on a wall, which allows a retailer to pass, or “swipe”, a credit card through the verification terminal or enter the equivalent data on an associated keypad. Verification terminals are widely distributed throughout the world. Verification terminals are the principle means of verifying credit card transactions by local retailers.

Large retailers have many terminals networked together via a serial connection. Although a serial port is often available, its use for local retailers is rare or non-existent because it requires specialized software loaded into the terminal as well as specialized software in order to communicate the request across a wide area network (WAN). This software must meet certification requirements imposed by financial institutions that run the verification centers. These certification requirements are cost prohibitive for the average retailer.

For local retailers, the transaction terminals typically include a telephone interface and a dial-up connection with a communication company. Referring to FIG. 8, the transaction terminals 6, 8 are configured to automatically dial a 1-800 telephone number upon passage of a card through a card reader. The call to the 1-800 number is made via the public switched telephone network (PSTN) 60. The call is typically routed through a local phone company which is part of the PSTN, to a national phone company and eventually to a communication company 300. The communication company 300 typically employs a modem bank 301 for processing the received calls. The modem bank answers each of the calls and forwards the requests to a protocol conversion device 302. The protocol conversion device determines the type of transaction, packetizes the data, and applies various protocol layers. The data is typically next logged in a host computer 303 and then forwarded via a leased line 305 to a financial company 304.

Typically, the routing of transactions through the communications company to the financial company is not apparent to the retailer. The retailer or consumer is often charged based on transactions with the financial institutions, and is often not charged directly by the communication company. In actuality, the retailer or consumer is communicating with a communication company hired by the financial institution in order to consolidate and route credit verification or ATM transactions from a plurality of different retailers. The financial institution hires the communication company and pays them from the fees collected from the retailers.

Small retailers must often choose between using their telephone line to communicate with the communication company for credit or ATM verification purposes, as described above, or receiving incoming calls from customers. Thus, retailers who desire to receive incoming calls and perform credit verification at the same time must incur the cost of an additional phone line dedicated to credit or ATM verification. In addition to the monthly cost of the phone line (approximately $30), the retailer also incurs the expense associated with the call to the 1-800 number and further incurs the expense of the transaction cost between the communication company and the financial institution. These costs are included in the fees that the financial institution eventually charges the retailer. Thus, the retailer has the combined costs of the dial up connection, the 1-800 long distance calls, the line costs between the communications company and the financial institution, and the protocol conversion costs of the communication company. All of these costs must be paid by the retailer either directly or via increased fees from the financial institution.

A problem arises in that the transaction costs to each of the thousands of different retailers around the country are extensive. Further, the reliability of the system suffers from the additional circuitry and data routing required to complete any transaction verification. Accordingly, it is required to find a solution which reduces the costs associated with these transactions while increasing the reliability.

### SUMMARY OF THE INVENTION

The above problems may be solved through a plurality of methods and apparatus described below.

In a first aspect of the invention, a VSAT network may be connected between the retailer and the communication company or directly to the financial institution.

In another aspect of the invention, the VSAT modem may include a reverse modem, which emulates the local loop of a PSTN. In this aspect of the invention, the VSAT network may be connected directly to the transaction terminal without modification or recertification of the transaction terminal.

A further aspect of the invention is to incorporate a reverse modem and/or wireless LAN directly into the indoor unit (e.g., a satellite modem or settop box). This provides a cost effective interface to support credit, ATM, or other applications in accordance with aspects of the present invention.

In further aspects of the invention, the VSAT modem may provide the local retailer with telephone access, Internet access, and broadband mass media services such as music and streaming video. In this manner, the VSAT local retailer may retrofit existing terminals and/or ATM machines which may render obsolete the retailer's need to have any services from the local phone company. This may be particularly important in rural areas and in developing countries where a local telephone network is not always as reliable as desired by the retailer.

Further aspects of the present invention include an interface for electronic card readers which may include, for example, a reverse modem which can be configured to emulate a public switched telephone network (PSTN)) at one interface and either a wireless LAN network or a VSAT modem on the other interface. In this aspect of the invention, existing transaction verification equipment may be retrofitted with a VSAT network.

In still other aspects of the invention, the transaction terminal may connect to or be integral with a VSAT modem. A transaction interface module may emulate a public switched telephone network (PSTN) interface and include a second interface to translates the modem signals to a predetermined protocol such as an asynchronous protocol or a wireless LAN protocol for input into a VSAT modem. Software in either the interface or VSAT modem may repackage the data into another communication protocol such as IP, frame relay, cell relay, ATM, or other suitable protocol for transmission over the VSAT network.

In still further aspects of the invention, it was determined that a random access mode VSAT works well with transaction processing. The VSAT may include a demand assigned mode where uplink communications require greater bandwidth such as when the VSAT is used to upload files.

In additional aspects of the invention, an interface may be coupled to a transaction terminal to communicate with an IDU (In Door Unit) via a serial port, wireless LAN, fire wire interface, or other suitable communication link. The existing phone line wires may be utilized to route the communication to/from the transaction terminals and the VSAT modem. Alternatively, a wireless LAN may be utilized.

Accordingly, the advantages of the VSAT transaction system include: 1) avoiding the cost of developing the software associated with modifying a conventional transaction terminal; 2) avoiding the cost of downloading software and performing field upgrades of transaction terminals; 3) avoiding increased complexity and potential errors in upgrading the transaction terminals in thousands of different retail centers; 4) increasing the reliability of the communication connection between the retailer and the financial institution; 5) avoiding the reliability problems normally associated with a modem bank; 6) allowing phased implementation of the VSAT system by connecting to the new VSAT connection while maintaining the old dial-up connection; 7) allowing the retailer the added benefit of being able to connect over either the telephone line or the VSAT modem; and 8) increasing the retailer's options without reconfiguring the transaction terminal ensuring substantially higher reliability levels.

In still further aspects of the invention, the VSAT modem may provide a reverse modem interface to any existing data networking equipment that has a modem interface. An example of such data networking equipment may be a set top box used for Internet-based television, such as AOLTV and WebTV. These boxes, which traditionally use an analog modem and telephone line to deliver data to a television set, may now be used with the VSAT modem. In still further embodiments, the VSAT system of the present invention may emulate a phone line interface which may be utilized, for example, for facsimile (fax) transmissions and voice over Internet (VOIP) applications.

In still further aspects of the invention, AOLTV, WebTV, and/or other settop boxes may be configured to include an integral and/or attached wireless LAN interface. Thus, a single VSAT modem may support a plurality of settop boxes.

Additional exemplary embodiments of the present invention include PCI bus adapter having a reverse modem. In the PCI bus adapter the data from the reverse modem may be transmitted to the PCI bus of a personal computer (PC) and processed for transmission by a satellite. Data from the attached transaction terminal may be output through the on-board serial port of the PC for transmission via satellite.

Although the invention has been defined using the appended claims, the invention may further include one or more elements from the apparatus and methods described herein in any combination or subcombination. Accordingly, there are any number of alternative combinations for defining the invention, which incorporate one or more elements from the specification (including the drawings, claims) in any combinations or subcombinations.

The scope of the present invention will be apparent from the following detailed description, particularly when taken in conjunction with the accompanying drawings while the detailed description provides exemplary preferred embodiments of the invention, these are given as illustrations only, since various changes and modifications are within the spirit and scope of the invention as will be apparent to those skilled in the art.

### BRIEF DESCRIPTION OF THE DRAWINGS

FIG. 1 shows a block diagram of a VSAT transaction system in accordance with aspects of the present invention;

FIG. 2 shows a second exemplary block diagram of another embodiment of the VSAT transaction system in accordance with aspects of the present invention;

FIG. 3 shows a third exemplary embodiment in accordance with another embodiment of the VSAT transaction system;

FIGS. 4-7 show alternative embodiments of a Transaction Interface; and

FIG. 8 shows a typical arrangement with a communication company using 1-800 service to local retailers.

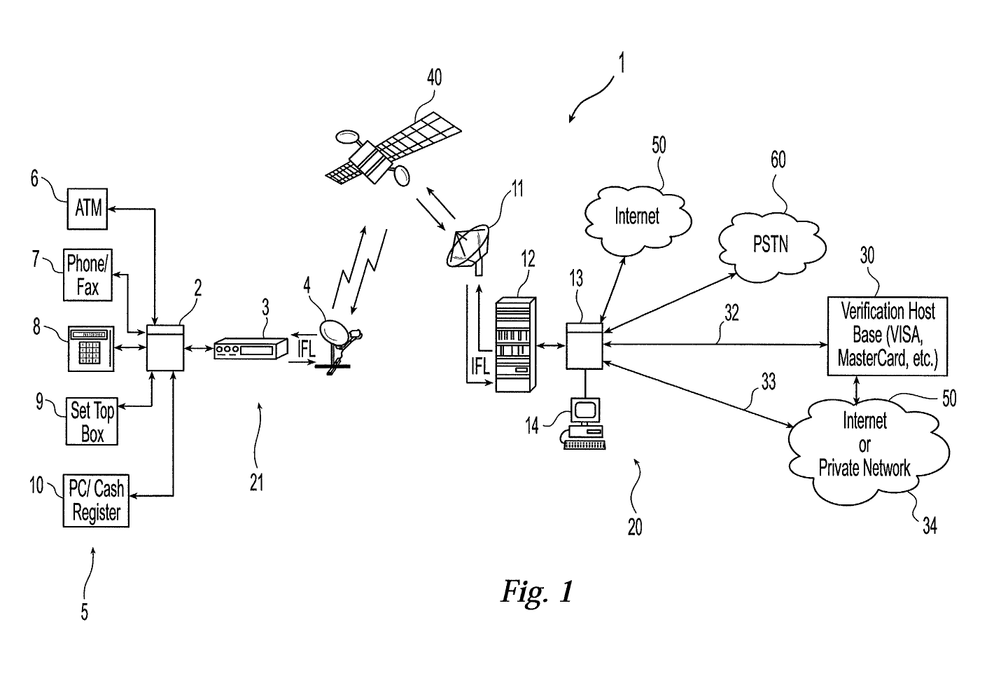

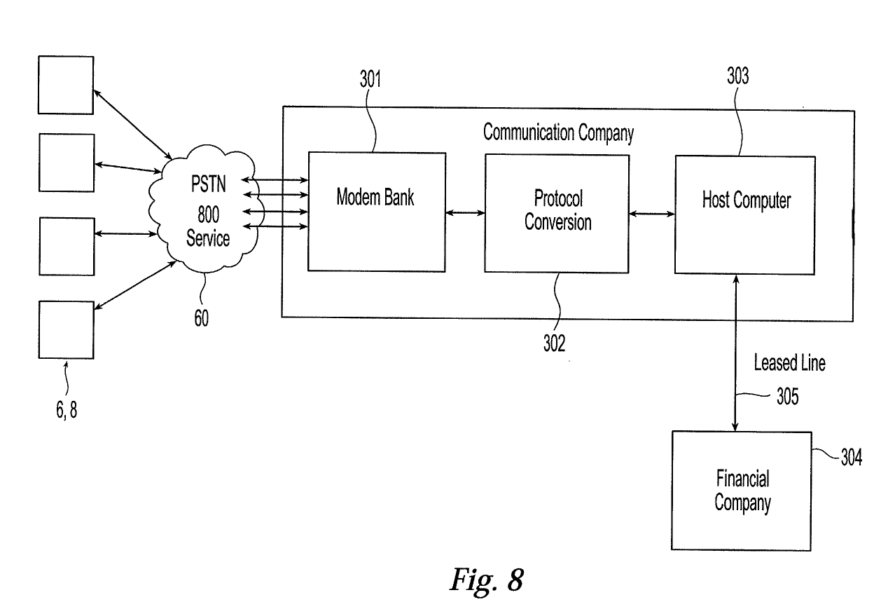

In FIGS. 1-8 similar reference numbers are used to represent similar elements.

### DETAILED DESCRIPTION OF THE INVENTION

Referring to FIG. 1, a VSAT transaction system 1 may include at a remote user site 21, such as a retailer or other user, a transaction interface module 2, a VSAT modem 3, an antenna 4, and a plurality of remote terminal devices 5 such as an automated teller machine (ATM) 6, a phone and/or facsimile 7, verification terminal 8, a settop box 9, and/or a PC/cash register 10. The VSAT transaction system 1 may include at the hub site 20 an antenna 11, receiver circuitry such as receivers and a multiplexer/demultiplexer or switch 12, a Hub server 13, and a control unit 14. The Hub site 20 may be connected to the remote user site 21 via a satellite 40. The Hub site 20 may also be coupled (e.g. via the hub server 13) to one or more financial center 30 via a suitable means of connection such as a leased line 32 and/or a network connection such as the Internet, ATM, frame relay, cell relay, IP or other wide area network (WAN) 34. It may be desirable to use the leased line 32 to interface to the financial center 30. The Hub server 13 may also be connected to various networks 50 such as the internet, a public switched telephone (PSTN) 60.

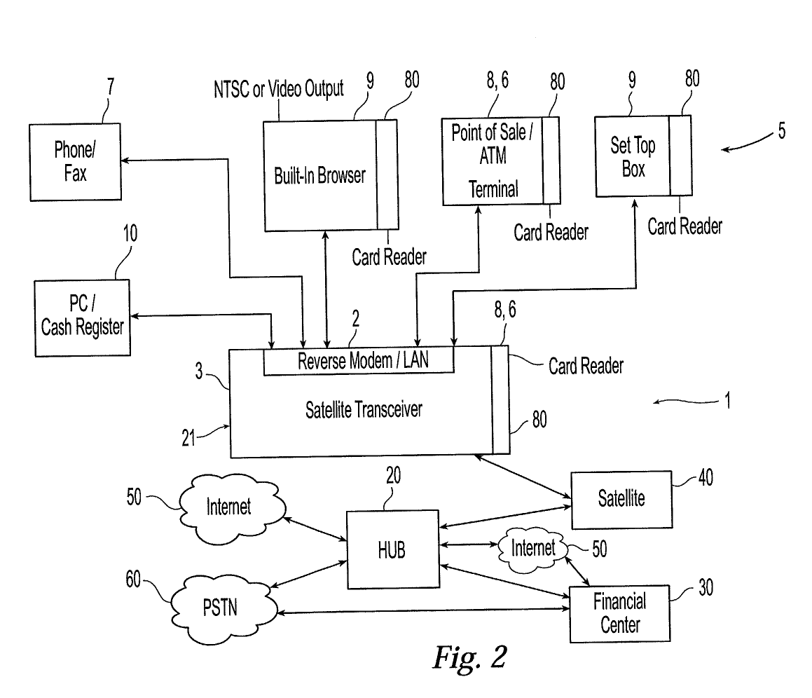

FIG. 2 shows a simplified block diagram of another embodiment of the VSAT transaction system 1. In the embodiment shown in FIG. 2, the ATM terminal 6 and/or verification terminal 8 may be incorporated directly into the VSAT modem 3. Alternatively, they may be coupled as peripherals via a transaction interface module 2. The transaction module 2 may be separate from or built into the VSAT modem 3. A card reader 80 may be integrated into one or more of the remote terminal devices 5 and/or VSAT modem 3.

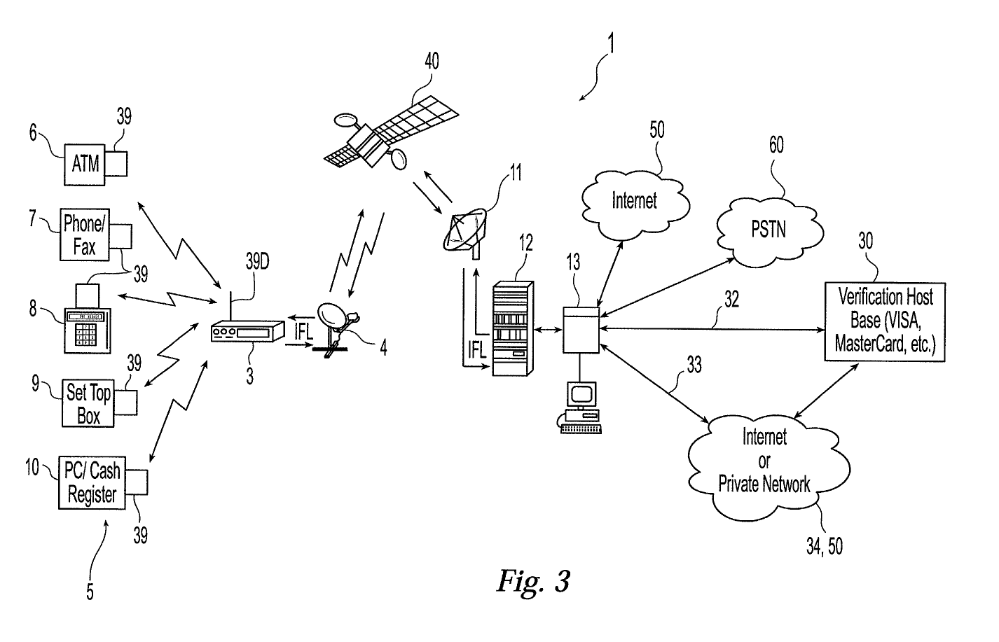

FIG. 3 illustrates another embodiment of the VSAT transaction system l. In this embodiment, the VSAT modem 3 may include either an integral or add-on wireless modem which communicates with one or more of the remote terminal devices 5. The remote terminal devices 5 may include a wireless LAN interface 39 and/or directly connect to the VSAT modem 3. The wireless LAN interface 39 may be variously configured as described in more detail below.

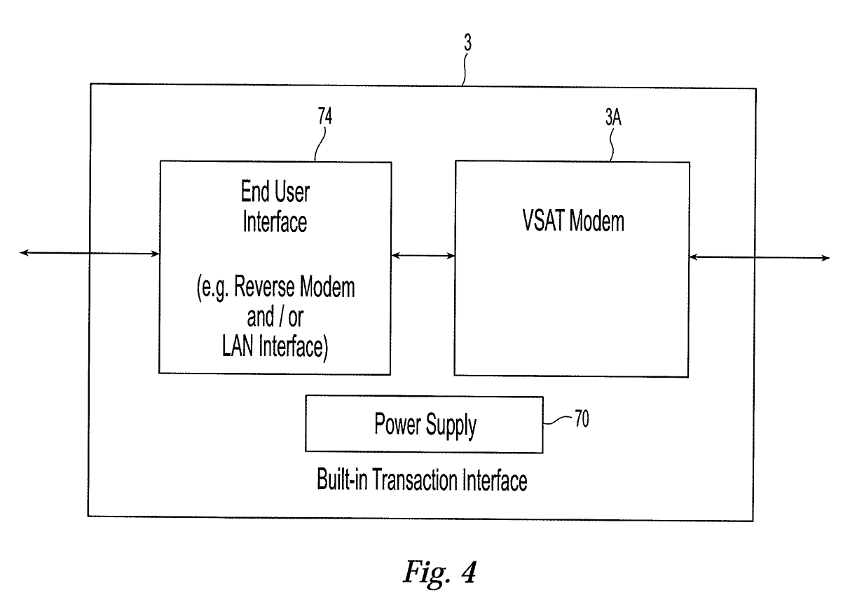

FIG. 4 illustrates a simplified block diagram of a transaction interface 2 configured to be built into the VSAT modem 3. The VSAT modem 3 includes both the end user interface 74 such as a reverse modem and/or wireless LAN as well as the VSAT modem circuitry 3A. In built-in configurations, both the VSAT modem circuitry 3A and end user interface 2 preferably share a single power supply 70 and common enclosure. The VSAT modem may alternatively be configured as an indoor unit and/or as a satellite settop device (e.g. a device capable of receiving digital satellite television signals).

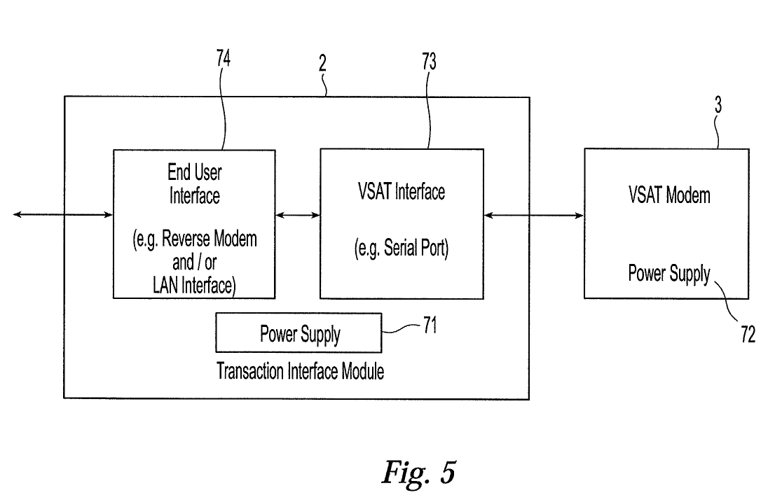

FIG. 5 illustrates a simplified block diagram of another embodiment of the transaction interface 2. In this embodiment, the transaction interface 2 may beconfigured as a module in a stand-alone configuration. In the stand-alone configuration, the transaction interface 2 includes an end user interface 74 and a VSAT interface 73. The VSAT interface 73 and the End User Interface 2 may share a common power supply and enclosure. The VSAT Interface 73 and/or the end user interface 74 may packetize and/or depacketize the data as well as add protocol layers prior to sending the data to the VSAT modem 3 and/or one or more of the remote terminal devices 5.

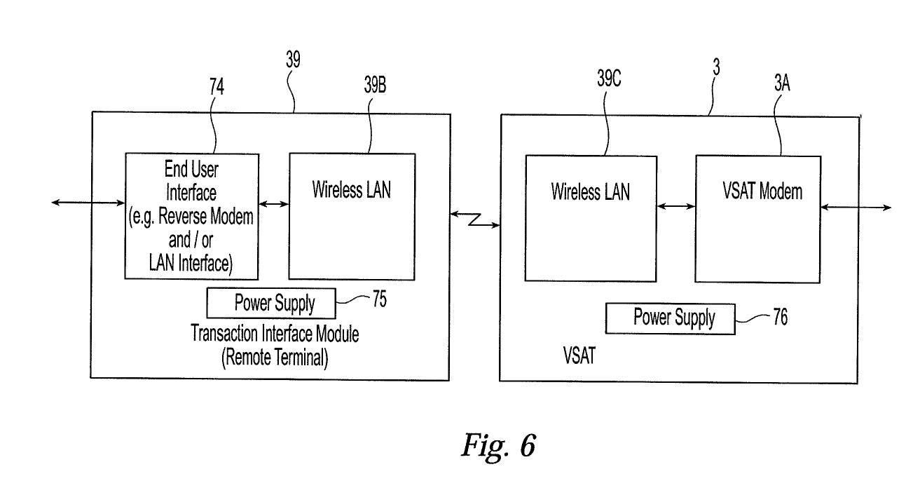

FIG. 6 illustrates a simplified block diagram of a wireless remote terminal transaction interface module 39. In this embodiment, the wireless transaction interface module 39 includes an end user interface 74 and a wireless LAN interface 39b. In embodiments using the wireless remote terminal transaction interface 39, it may be desirable to build a wireless LAN interface 39c and VSAT modem circuitry 3a into the VSAT modem 3. The end user interface 74 may be configured to assemble/disassemble the data as packets responsive to a suitable source/destination address. The end user interface 74 may also be configured to provide protocol layering for communication with VSAT modem 3. The remote terminal transaction interface module 39 may have a separate power supply 75 from the power supply 76 of the VSAT modem 3.

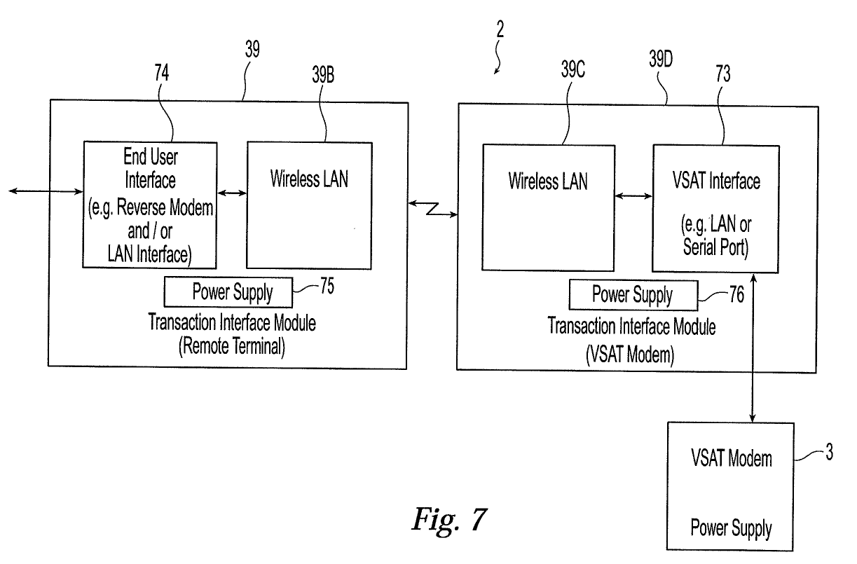

FIG. 7 illustrates a simplified block diagram of a wireless remote terminal transaction interface module 39. This embodiment operates in a similar manner as described above with respect to FIG. 6 with the exception that a VSAT modem transaction interface module 39D may be disposed between the VSAT modem 3 and the wireless remote terminal transaction interface module 39. The wireless VSAT modem transaction interface module 39d may include a wireless LAN interface 39c and a VSAT interface 73 as described above. When protocol conversion and/or packetization is employed, it may be performed in the VSAT interface module 73 the VSAT modem 3 and/or in the end user interface 74. The protocol conversion and/or packetization may alternatively be configured to perform switching and routing functions to a plurality of PC devices within a home or retail location. In many embodiments, it may be desirable to include the protocol conversion and/or packetization in the end user interface module 74 to preserve the identity of the remote terminal devices 5. The identity of the remote terminal devices 5 may be included in the information sent to the VSAT modem. This allows the hub to correctly route the data. In this embodiment there may be separate power supplies for each of the wireless remote terminal transaction interface modules 39, for the single VSAT modem transaction interface module 39d and/or for the VSAT modem 3.

In operation, the VSAT transaction system 1 may include a reverse modem in the transaction interface 2 that receives calls from the ATM 6, phone/FAX 7 and/or verification terminal 8. The transaction interface module may also include either a reverse modem and/or other type of communication interface such as a LAN interface for communicating with one or more settop boxes 9 and/or one or more PCs/Cash registers 10. The transaction interface module collects data from the various remote terminals 5 and may either forward the data to VSAT modem 3 or operate on the data. Where the transaction module 2 operates on the data, it may be desirable to pocketsize the data into a suitable protocol such as IP, frame relay, cell relay, ATM, or other suitable protocol. In many embodiments, IP protocol may be utilized since the data may then be routed over the Internet without further processing. If the data is not packetized and/or formatted in the transaction module 2, this packetization may optionally occur in the VSAT modem 3. In systems where only a single remote terminal device is present, adding address layers and/or packetization of data may or may not occur.

Whether packetized or not, the VSAT modem 3 transmits the data to the satellite 40 via antenna 4. The satellite 40 then relays the data to receiver circuitry 12 via antenna 11. Thereafter, the data may be recovered by receiver circuitry 12 and forwarded to the hub server 13. The hub server 13 may forward the data to the Internet 50, PSTN 60, leased line 32, and/or one or more private networks 34. Where the data is packetized, the packetization and/or other protocol layers may be removed before forwarding to an external network. For example, where the data is to be sent to the PSTN, it is often desirable to either reformat the data as ATM data and link with the digital part of the PSTN or reformat into analog data and output to the analog portion of the PSTN. A digital link into the PSTN is often more desirable. Web requests may be sent to and received from the Internet. Similarly, financial transactions may be forwarded to the financial center 30 via the Internet or other private network 34 and/or via a leased line 32.

Communication in reverse direction operates as described above only in reverse. For example, data such as acknowledgements and transaction verification may be sent from the financial center 30 via the leased line 32 and/or wide area network 34 to the hub server. The hub server may then format the data for distribution to remote user site via the receiver circuitry 12 (which also includes a transmitter), the antenna 11, and satellite 40. While there may be many remote user sites, usually the remote user site to which the transactions are address operates on the transaction. The transaction may be received by the remote user site via the antenna 4 and VSAT modem 3. Where there are several attached devices, data may be routed to the appropriate attached device via an address header. In either the VSAT modem 3 and/or the transaction interface 2, the data may be reformatted to communicate with the appropriate remote terminal device 5. The reformatting may, where a reverse modem is used, output the data in a DTMF or other suitable modem format to the remote terminal device 5.

FIG. 2 operates in a similar fashion. In FIG. 2, the transaction interface 2 (e.g., reverse modem, or other suitable interface) may be separate, directly attached, or integrated into the VSAT modem 3. Further, the VSAT modem may directly include one or more transaction terminals 6, 8. Where the VSAT modem integrates one or more transaction terminals 6,8, the modem may include a card reader 80 to read checking and/or credit/debit card transactions. Alternatively, one or more of the remote terminal devices 5 such as the phone, settop box 9 and/or the transaction terminals 6,8 may include a card reader 80. FIG. 2 may operate in a similar manner as described above with respect to FIG. 1.

FIG. 3 may operate in a similar manner as described above for FIGS. 1 and 2, but with one or more of the remote devices being connected by a wireless LAN and/or another wired interface (e.g., LAN, telephone wire, and/or serial port). Where the remote terminal devices 5 are coupled via a wireless LAN, packetization and encapsulation of the data (e.g., in IP, ATM, frame relay, cell relay, and/or other suitable protocol) may be desirable. Where packetization and/or encapsulation occurs, it may be desirable to incorporate the circuitry for encapsulation into the wireless remote terminal transaction interface 39 and/or into the VSAT modem 3 and/or a module attached to the VSAT modem 3.

FIGS. 4-7 show alternate configurations of the end user interface 74, wireless LAN transaction interface modules 39B, 39C, VSAT interface 73, and/or VSAT modem 3. One or more of the configurations shown in FIGS. 4-7 may be utilized with any of the VSAT transaction systems 1 shown in FIGS. 1-3. Further, the packetization and/or encapsulation/unencapsulation may occur in any one or more of: a)the end user interface 74, b) wireless LAN transaction interface modules 39B, 39C, c) VSAT interface 73, and/or d) VSAT modem 3. Where packetization and/or encapsulation is employed, it may be desirable to include a CPU, memory, and/or dedicated application specific integrated circuit (ASIC) in any one or more of the end user interface 74, wireless LAN transaction interface modules 39B, 39C, VSAT interface 73, and/or VSAT modem 3 to perform the packetization/depacketization and/or encapsulation/unencapsulation functions.

The VSAT transaction system 1 may provide various services to the remote user site 21. For example, a transaction terminal 6, 8 at a retailer's location may be connected directly to a VSAT network. In order to accomplish this connection without having the retailer incur the additional software updates of the transaction terminal, the VSAT modem may be configured to emulate a telephone line interface using a reverse modem. For example, when the modem is taken off-hook and connected to a standard telephone line, a series of voltages may interact with the modem to provide a dial tone and allow the modem in the transaction terminal 6, 8 to dial a particular number. Using the present system, the VSAT may provide a reverse modem which includes all of the signaling necessary to communicate with a standard transaction terminal. The reverse modem may include suitable dual-tone multi-frequency (DTMF) signals in order to receive information from and transmit information to the transaction terminal.

The replacement of the conventional communication line with a VSAT network has substantial benefits for the average retailer. For example, most retailers today require Internet access for business purposes. The availability of the VSAT providing communication to the transaction terminal also enables the retailer to have high-speed Internet access via, for example, a separate interface into the VSAT modem. The separate interface may include a local area network (LAN) interface, a serial interface, and/or a standard modem interface. Broadband Internet access allows the retail outlet to, for example, maintain a local web page describing the services provided by the local retailer, access the Internet to lookup inventory options, download software, and update remote databases, connect cash registers and/or PCs to a remote inventory system and other similar benefits. The local retailer may also utilize the VSAT for receiving E-mail from customers and maintain his WEB page in real time without having to tie up an existing phone line or pay the added cost of a DSL and/or cable modem.

In addition, the VSAT connection allows the local retailer to receive broadband communications such as, for example, music channels and streaming video to be transmitted to the store and played for customers. In this manner, sports bars can receive audio and video sports channels.

The local retailer may utilize the VSAT connection for other wide-area applications such as private communications with the retailers' headquarters. For example, a portion of the VSAT bandwidth may be dedicated to providing a private wide area network (WAN), allowing the local retailer a private network (e.g., tunneled) connection to the main office. This is helpful for various applications such as inventory management and sales reporting. A computer (e.g., PCs/cash registers 5) located at the local retailers may appear to be located at the main office of the retailer. Thus, the local retailer would have all of the main office applications available locally as desirable. For example, a gas station, belonging to a company such as Exxon, may have a direct access to Exxon's network. Thus, all dealers can be provided with specialized services from Exxon such as car repair manuals, inventory management, expected gas pricing trends, and other information. Alternatively, the private WAN may be encrypted and/or be provided with other secure tunneling techniques to communicate across the Internet.

In the event that the local retailer's main headquarters is not of sufficient size to have a VSAT hub, the retailer may share a single VSAT hub with many other retailers and have the communications to and from the head office “backhauled” over the Internet, a leased line, or other wide area network 34. In this manner, whether direct or via the Internet, the VSAT allows the local retailer to have a presence on the corporate WAN in a manner that may be completely transparent to the local retailer. In addition, the local retailer may also benefit from having Internet access and protection of local data via firewalls installed on the local retailers' computer equipment.

While the preceding examples describe the present invention in the context of a retailer, the invention is not so limited. For example, in other aspects of the invention, the VSAT modem may also be utilized in other installations such as automatic teller machines (ATMs). Typically an ATM has an output that requires a connection to a modem. The modem connection to a standard telephone line may similarly be replaced by a connection to a reverse modem in a VSAT modem in accordance with aspects of the present invention. An ATM may encrypt transactions going to and from the reverse modem and into the VSAT network. Further, the VSAT network may use the private tunneling arrangements discussed above to communicate the transactions to the financial institution associated with the ATM. Thus, many retailers include both verification terminals 8 and ATMs 6. Both of these connections may be connected to the same VSAT modem.

Where the VSAT modem is located in a bank branch, the VSAT modem may be utilized not only to service the bank's automatic teller machines, but also to provide a full range of communication services to the local branch. For example, at the local bank branch, the VSAT may provide an Internet connection for the employees, phone connections, security connections to monitor employees, monitor for security such as break-ins/bank robbers, as well as connections to the main office of the financial institution.

As a further example, both an ATM and a verification terminal may be co-located in a local retailer store. For example, where a bar or other merchant incorporates an ATM, the ATM may share the VSAT for providing secure communications to confirm ATM transactions at the same time that the transaction terminal shares the same VSAT modem. In this embodiment, the VSAT modem may include two, three, four, or more reverse modem connections for respectively communicating with ATMs, transaction terminals, settop boxes, facsimile machines, etc. In other embodiments, the ATM and the transaction terminal may share a single reverse modem in the VSAT modem such that software in each of the respective machines checks to determine whether the line is in fact currently off-hook before initiating the transaction.

In further example embodiments, the VSAT modem may have any number of reverse modem connections, which allows a plurality of simultaneous connections to different transaction equipment to share the VSAT modem simultaneously. This has substantial advantages in that a small business such as a bar or other retail establishment may include a plurality of both ATMs and transaction terminals located throughout the establishment. In such a manner, a single VSAT connection may be utilized to replace numerous existing connections with transaction terminals and ATMs, all routed through the VSAT.

In still further examples, the VSAT transaction system may be utilized to provide financial institution verification of scanned coding numbers on the bottom of a check. This enables a retail outlet to verify check purchases. Further, the retailer may enter in the amount of the check and have the amount deducted immediately from the account of the user shown on the check.

In still further example embodiments of the invention, a retailer who cashes paychecks for employees may include a connection between processing equipment that receives the scanned account numbers on the paycheck, verifies the monies associated with the paycheck, and allows the retailer to make instant payments to the employee associated with the paycheck. This system may also be connected to the VSAT via a reverse modem connection, serial connection, or other suitable connection.

Where related retail chain outlets are disbursed across the United States, it is often advantageous to provide security systems for the individual retail outlets. Currently, the retail outlets each require a telephone dial-up line that sends security signals back to a main office or to a security company. However, in a network environment that utilizes a VSAT connection, a local retailer may subscribe to a service whereby a camera may be connected via a reverse modem or other suitable connection directly to the VSAT network. This allows a centralized security system for the company to monitor the respective retail outlet locations at all times, regardless of whether the respective location is open for business or not. The respective retail outlets may also be monitored full time by a security company and part time by the main retail office to ensure employee honesty. These transactions may be processed simultaneously via streaming video. Accordingly, the retail company has the added benefit in that the retail company may not only ensure greater security and safety for its employees, but may also monitor its employees for improper practices with customers, abusive tactics with customers, and for the trustworthiness of their employees.

In addition to the aforementioned devices, the present invention may enable other devices already located in the retail outlets to be connected directly to the reverse modem without the substantial software upgrades and/or hardware upgrades. For example, where a gas station has each of its pumps connected to a modem for communication back to a central office, this service may now be performed by a VSAT modem by simply retrofitting the reverse modem and connecting to the telephone line that was previously connected to each of the pumps.

With respect to the communication company, currently there is an extensive process whereby the communication company becomes certified both in its transmission of the backhaul transmissions as well as the processing provided by the communication company of the transactions. The certification confirms the processing is done in a secure and reliable manner. The certification process is extensive, time consuming, and fraught with bureaucratic traps. Further, any modification of the transaction terminal has similar certification requirements that increase the barriers of entry to anyone making modifications of the transaction terminal. Accordingly, an aspect of the present VSAT network may be to emulate via reverse modem the modem interface of the transaction terminal at the retailer as well as the interface between the modem bank and the communication company.

When communicating with the communication company via the VSAT modems associated with embodiments of the present invention, the VSAT modem may encapsulate or configure the communications from the transaction terminal into a protocol format. In one exemplary embodiment, the protocol format is IP. In other embodiments, frame relay, asynchronous transfer mode, or other suitable protocol may be utilized for transmitting the data from the transaction terminals via a satellite to a hub location. The hub location is preferably co-located with the communication company's equipment and the hub location provides the output of all of the packets, frames, and/or cells from the various retail outlets directly into a protocol conversion device of the communication company. The use of the VSAT and the pre-encapsulated or pre-formatted data from the transaction terminal may eliminate the need for a modem bank at the communication compare as well as the need for a statistical multiplexer switch at the communications company. Thus, the use of the VSAT and associated preformatting at the retailer location eliminates the substantial expense of having and maintaining a modem bank with a plurality of modems and a statistical multiplexer at the location of the communication company.

In addition to the elimination of complexity and hardware at the communication company, embodiments of the present invention also eliminate the 1-800 fees associated with the dial-up connections to the communications company. Additionally, the connections are of higher reliability because the modem bank is susceptible to a myriad of failures such as modems hanging up, modems with incomplete connections, a failure of the modem and associated processing equipment. Because of the number of modems required in the modem bank, the reliability is typically less than that of a VSAT network.

Accordingly, the communication company increases reliability and decreases costs through the use of a VSAT connection while avoiding the large efforts required for recertification of the overall network. In addition, the communication company avoids the requirement for paying for a large number of local lines into the modem bank. For example, where the modem bank has 4000 modems, the communication company would require 4000 separate lines into the modem bank from the local phone company and then from the modem bank to the switch/statistical multiplexer and then into the protocol conversion.

In accordance with embodiments of the present invention, the VSAT network may be able to replace the current communication network of a plurality of retailers without having the retailers renegotiate their relationship with the particular financial institutions. For example, a VSAT company may contract with a number of communication companies such that the VSAT company has an access port into the communication company's internal network. The VSAT company may thereafter supply a large number of retailers with a VSAT transaction system such that the retailers utilize the VSAT company's network to provide their transactions to the communication company without ever impacting the relationship that the retailer has with the financial institution. In this manner, a VSAT company that contracts with each of the communication companies has access to substantially all retailers. Thus, the VSAT network in accordance with the present invention renders land lines currently associated with virtually every retail location obsolete.

In alternative embodiments of the present invention, the communications company itself may determine to provide VSAT networks to various retailers. For example, retailers that have high call volume may benefit substantially from using a VSAT network. The communications company may either provide the VSAT network between the retailer and the communications company or alternatively may target certain retailers for direct communications with the financial institution via the VSAT network. This saves substantial backhaul charges by the communication company and allows the communication company to route high transaction volume retailers to the point of presence closest to the financial institution, minimizing or eliminating backhaul charges.

In still further embodiments of the present invention it is possible to completely eliminate the communication company by having the retailer communicate directly with the financial institution. For example, where a VSAT hub is located at the financial institution or with connectivity to the financial institution, it may be desirable to incorporate within the VSAT hub the protocol conversion necessary to communicate directly with the financial institution thus avoiding the necessity of going through the communication company. Accordingly, the financial institution may maintain a direct relationship with its retailers, particularly those retailers with high call volumes, and bypass the charges associated with the communication company. This allows the financial institution to offer credit card transaction services to the retailer at a lower percentage of the transaction, avoiding the fees associated with the communication company.

In certain installations, a problem arises in that the phone lines internal to the retail outlet are of poor quality. Additionally, it may be difficult to wire the various transaction terminals, automatic teller machines, computers, and/or phones to the VSAT. Accordingly, a solution is required to allow inexpensively retrofit the wiring of all of the various phone, automatic teller machines, and/or transaction terminals to the VSAT. In yet another embodiment of the present invention, the reverse modem is packaged separately in a reverse modem module for co-location next to the transaction terminal or automatic teller machine. The reverse modem module may include a standard RJ11 telephone connection for plugging directly into the transaction terminal or ATM. The reverse modem module also includes a wireless LAN connection for communicating in a wireless manner with the VSAT modem. Further, a power supply may be included for powering the reverse modem and wireless LAN. The reverse modem module may be made today for as little as $15. It is anticipated that the reverse modem module price will decrease over time. The use of the reverse modem module facilitates the sale of the VSAT in kits for installation by the local retailer. Even if professionally installed, it is often cost effective to use the reverse modem modules to wirelessly connect to the VSAT rather than use existing cabling or rewire the retailer. Further, the reverse modem may be utilized with conventional phones or IP phones to provide a total solution for the retailer, bypassing the local phone and cable company altogether. Various embodiments for providing this functionality are described in FIGS. 4-7.

In still further embodiments, the interface device may be integrated into a adaptor card for use in a PC or configured as an add-on unit plugging into a serial port of an existing satellite modem.

While the present invention has been described in terms of a VSAT modem, the invention is not so limited. For example, the VSAT modem may be reconfigured as a direct satellite settop terminal. Similarly, the interface module may be integrated directly into the settop terminal and provide a router device for use in a retail outlet, business, or home. The router may route television signals and/or data to any of the connected devices via the wireless LAN. While the present invention is most useful in the context of a retail outlet, other applications may be envisioned. Where the wireless LAN is integrated into the settop terminal, it is desirable to locate one or preferably two antennas outside of the settop box and shielded from the receiver circuitry associated with the satellite receiver. Similarly, the wireless LAN circuitry may be shielded from the circuitry associated with the satellite receiver. In still further embodiments of the present invention, the wireless LAN may be co-located with and/or integral with the antenna dish. In these embodiments, a cost savings is provided because the satellite receiver, LNB, antenna, and/or LAN are located proximate to each other and/or share the same housing. Further, any number of settop boxes or other remote terminals may be located throughout the retail, business, or residence for receiving data, audio, and/or video signals from the antenna.

We claim:

1. An apparatus comprising VSAT modem having an integral reverse modem.

2. The apparatus of claim 1 including a transaction terminal wherein the VSAT modem is coupled to the transaction terminal via the integral reverse modem.

3. The apparatus of claim 2 wherein the VSAT modem includes a wireless LAN wherein the transaction terminal is coupled to the reverse modem via the wireless LAN.

4. The apparatus of claim 1 including a plurality of transaction terminals wherein the VSAT modem includes router for routing data to the plurality of transaction terminals.

5. An apparatus comprising:
a VSAT modem including a reverse modem;
a transaction terminal coupled to the reverse modem.

6. The apparatus of claim 5 wherein the VSAT modem includes a wireless LAN wherein the transaction terminal is coupled to the reverse modem via the wireless LAN.

7. A method comprising coupling a transaction terminal to a VSAT indoor unit via a reverse modem.

8. A method comprising coupling a transaction terminal to a VSAT modem via wireless LAN and a reverse modem.

9. An apparatus comprising a VSAT modem including a built-in wireless LAN.

10. An apparatus comprising; a VSAT modem; a transaction terminal; a wireless LAN coupled to the VSAT modem; and a reverse modem coupled between the wireless LAN and the transaction terminal.
